(19) United States
(12) Patent Application Publication
(10) Pub. No.: US 2004/0085332 A1
(43) Pub. Date: May 6, 2004

(54) Display driving method and display device

(75) Inventors: Hiromitsu Nakaoka, Kyoto-shi (JP); Toshimasa Tanaka, Kyoto-shi (JP)

Correspondence Address: MERCHANT & GOULD PC, P.O. BOX 2903, MINNEAPOLIS, MN, 55402-0903, US

(73) Assignee: Rohm Co., Ltd., Kyoto-shi (JP)

(21) Appl. No.: 10/695,272

(22) Filed: Oct. 27, 2003

(30) Foreign Application Priority Data
Oct. 28, 2002 (JP) 2002-312362
Oct. 28, 2002 (JP) 2002-312363

(51) Int. Cl. G09G 5/10

(52) U.S. Cl. 345/691

(57) ABSTRACT

A PWM signal voltage to be applied to each of signal voltages X1 to X4 of a simple matrix display to be PWM controlled is controlled in such a manner that the numbers of forward approach signal voltages and rearward approach signal voltages are almost equal to each other for a certain scanning electrode within an optional period.

### BACKGROUND OF THE INVENTION

1. Field of the Invention

The present invention relates to a display driving method for PWM controlling a simple matrix display using a liquid crystal display unit or an organic EL display unit, and a display device thereof.

2. Description of the Related Art

A matrix type display device is roughly divided into an active matrix type having a nonlinear unit such as a transistor on each pixel at an intersection of a scanning electrode and a signal electrode and a simple matrix type having each pixel on the intersection connected directly to a display unit without the nonlinear unit. As shown in a basic structure of FIG. 10, a simple matrix display 70 is provided with a plurality of signal electrodes X (X1 to X4) and a plurality of scanning electrodes Y (Y1 to Y4) which are orthogonal to each other over two opposed substrates. The signal electrodes and the scanning electrodes are usually constituted by a large number of electrodes respectively, and description will be given to an example in which four signal electrodes and four scanning electrodes are provided.

As shown in a timing chart of FIG. 11, a scanning voltage is applied to the scanning electrodes Y1 to Y4 in order synchronously with the scanning clock of a scanning side driving circuit 71, that is, a signal fetch latch pulse LP, and at the same time, a signal voltage is applied from a signal side driving circuit 72 to the signal electrodes X1 to X4. In that case, a cross talk phenomenon is generated between each scanning electrode and each signal electrode due to capacitive coupling of a display unit (for example, a liquid crystal display unit or an organic EL display unit), and a low voltage is applied to pixels other than the selected pixels. With the structure of the simple matrix display, the cross talk phenomenon cannot be avoided. Usually, a display characteristic is not greatly influenced by the cross talk phenomenon.

The scanning voltage and the signal voltage are repetitively applied every frame representing image data for one screen so that an image is displayed on a display.

In order to control the display gradation of the simple matrix display, the signal voltages to be applied to the signal electrodes X1 to X4 are PWM controlled (Pulse Width Modulation). In this case, a signal voltage having a width controlled corresponding to each pixel is applied to each of the signal electrodes X1 to X4 as shown in (ii) to (v) of FIG. 8. In this example, there is shown a rearward approach in which each signal voltage is applied to a rear portion in a predetermined width from the midway position of an interval period Ti of a scanning clock LP to a final position.

In the PWM control, a noise voltage Vnz-x1 is generated as typically shown in (vi) of FIG. 11 referring to the signal electrode X1 at the change point of each signal voltage (a rise point in this case), and the noise voltage Vnz-x1 fluctuates the electric potentials of the scanning electrodes Y1 to Y4. Moreover, noises shown in \mathring{3} and \mathring{2}′ of the drawing are also generated for each end point of the interval period Ti of the scanning clock LP, and consequently, influence of the cross talk is increased due to the noise voltage as shown in Vnz-x1.

On the other hand, noises shown from \mathring{1} to \mathring{4} of the drawing are generated, such as shown in the noise voltage Vnz-x1 to Vnz-x4, by which influence of the cross talk is also increased.

Referring to the other signal electrodes X2 to X4, similarly, noise voltages Vnz are generated to fluctuate the electric potentials of the scanning electrodes.

These noise voltages Vnz are always generated with a polarity in the same direction for the same scanning period (for example, Y1) every frame. Therefore, display shade or display unevenness is apt to be generated on the display screen, causing a deterioration in display quality. Also in case of a forward approach in which the signal voltage by the PWM control is applied to a front part in a predetermined width from the first part of the interval period Ti of the scanning clock LP, the polarity of a noise is simply changed in the same manner.

### SUMMARY OF THE INVENTION

Therefore, it is an object of the invention to provide a display driving method for a simple matrix display which can substantially eliminate an influence, on screen display, a noise voltage generated at time of the rise or fall of a signal voltage in PWM control, and a display device thereof.

A first aspect of the invention is directed to a display driving method of a simple matrix display to be PWM controlled,

wherein a forward approach PWM signal voltage and a rearward approach PWM signal voltage can be selectively supplied as PWM signal voltages to be applied to signal electrodes, and

the PWM signal voltage to be applied to each of the signal electrodes within a predetermined period is controlled in such a manner that numbers of the forward approach PWM signal voltages and the rearward approach PWM signal voltages are almost equal to each other in relation to each scanning electrode.

A second aspect of the invention is directed to the display driving method according to the first aspect of the invention, wherein the forward approach PWM signal voltage and the rearward approach PWM signal voltage are switched every predetermined frame cycle.

A third aspect of the invention is directed to the display driving method according to the first or second aspect of the invention, wherein the PWM signal voltage is applied to have a rearward/forward approach combination in which the rearward approach PWM signal voltage is applied to an odd-numbered scanning electrode and the forward approach PWM signal voltage is applied to an even-numbered scanning electrode and a forward/rearward approach combination in which the forward approach PWM signal voltage is applied to the odd-numbered scanning electrode and the rearward approach PWM signal voltage is applied to the even-numbered scanning electrode.

A fourth aspect of the invention is directed to the display driving method according to any of the first to third aspects of the invention, wherein the PWM signal voltage and a scanning voltage to be applied to the scanning electrode are alternated synchronously to have a predetermined relationship with a frame cycle.

A fifth aspect of the invention is directed to a display device comprising:

a simple matrix display provided with a plurality of signal electrodes and a plurality of scanning electrodes which are orthogonal to each other with an electrostatic capacity coupling display unit interposed therebetween;

a scanning side driving portion for sequentially scanning the scanning electrodes and supplying a scanning voltage; and

a signal side driving portion for supplying a PWM signal voltage to be a forward approach PWM signal voltage or a rearward approach PWM signal voltage to each of the signal electrodes synchronously with the scan of the scanning side driving portion,

wherein the signal side driving portion controls the PWM signal voltage in such a manner that numbers of the forward approach PWM signal voltages and the rearward approach PWM signal voltages are almost equal to each other within a predetermined period for each of the scanning electrodes.

A sixth aspect of the invention is directed to the display device according to the fifth aspect of the invention, wherein the signal side driving portion switches the forward approach PWM signal voltage and the rearward approach PWM signal voltage every predetermined frame cycle.

A seventh aspect of the invention is directed to the display device according to the fifth or sixth aspect of the invention, wherein the signal side driving portion applies the PWM signal voltage to have a rearward/forward approach combination in which the rearward approach PWM signal voltage is applied to an odd-numbered scanning electrode and the forward approach PWM signal voltage is applied to an even-numbered scanning electrode or a forward/rearward approach combination in which the forward approach PWM signal voltage is applied to the odd-numbered scanning electrode and the rearward approach PWM signal voltage is applied to the even-numbered scanning electrode.

An eighth aspect of the invention is directed to the display device according to any of the fifth to seventh aspects of the invention, wherein the signal side driving portion and the scanning side driving portion synchronize and alternate the PWM signal voltage and a scanning voltage to be applied to the scanning electrode to have a predetermined relationship with a frame cycle.

A ninth aspect of the invention is directed to a display driving method of a simple matrix display to be PWM controlled, wherein numbers of signal electrodes to which a forward approach PWM signal voltage is to be applied and signal electrodes to which a rearward approach PWM signal voltage is to be applied are set to be almost equal to each other for each scanning period in which scanning electrodes are sequentially scanned.

A tenth aspect of the invention is directed to the display driving method according to the ninth aspect of the invention, wherein the signal electrode to which the forward approach PWM signal voltage is to be applied and the signal electrode to which the rearward approach PWM signal voltage is to be applied are set alternately.

A eleventh aspect of the invention is directed to the display driving method according to the ninth or tenth aspect of the invention, wherein the PWM signal voltage is applied to have a rearward/forward approach combination in which the rearward approach PWM signal voltage is applied to an odd-numbered scanning electrode and the forward approach PWM signal voltage is applied to an even-numbered scanning electrode or a forward/rearward approach combination in which the forward approach PWM signal voltage is applied to the odd-numbered scanning electrode and the rearward approach PWM signal voltage is applied to the even-numbered scanning electrode.

A twelfth aspect of the invention is directed to the display driving method according to any of the ninth to eleventh aspects of the invention, wherein the PWM signal voltage and a scanning voltage to be applied to the scanning electrode are alternated synchronously to have a predetermined relationship with a frame cycle.

A thirteenth aspect of the invention is directed to a display device comprising a simple matrix display provided with a plurality of signal electrodes and a plurality of scanning electrodes which are orthogonal to each other with an electrostatic capacity coupling display unit interposed therebetween, a scanning side driving portion for sequentially scanning the scanning electrodes and supplying a scanning voltage, and a signal side driving portion for supplying a PWM signal voltage to be a forward approach PWM signal voltage or a rearward approach PWM signal voltage to each of the signal electrodes synchronously with the scan of the scanning side driving portion,

wherein the signal side driving portion applies the forward approach PWM signal voltage to an almost half number of signal electrodes and applies the rearward approach PWM signal voltage to the residual signal electrodes for each scanning period in which the scanning electrodes are sequentially scanned.

A fourteenth aspect of the invention is directed to the display device according to the thirteenth aspect of the invention, wherein the signal side driving portion alternately sets the signal electrode to which the forward approach PWM signal voltage is to be applied and the signal electrode to which the rearward approach PWM signal voltage is to be applied.

A fifteenth aspect of the invention is directed to the display device according to the thirteenth or fourteenth aspect of the invention, wherein the signal side driving portion applies the PWM signal voltage to have a rearward/forward approach combination in which the rearward approach PWM signal voltage is applied to an odd-numbered scanning electrode and the forward approach PWM signal voltage is applied to an even-numbered scanning electrode or a forward/rearward approach combination in which the forward approach PWM signal voltage is applied to the odd-numbered scanning electrode and the rearward approach PWM signal voltage is applied to the even-numbered scanning electrode.

An sixteenth aspect of the invention is directed to the display device according to any of the thirteenth to fifteenth aspects of the invention, wherein the signal side driving portion and the scanning side driving portion synchronize and alternate the PWM signal voltage and a scanning voltage to be applied to the scanning electrode to have a predetermined relationship with a frame cycle.

### BRIEF DESCRIPTION OF THE DRAWINGS

FIG. 1 is a diagram showing the structure of a display device according to the invention,

FIG. 2 is a diagram showing the structure of a signal side driving circuit in FIG. 1,

FIG. 3 is a diagram showing an example of the structure of a data selector in FIG. 2,

FIG. 4 is a timing chart for a display device according to a first embodiment,

FIG. 5 is a timing chart for a display device according to a second embodiment,

FIG. 6 is a timing chart for a display device according to a third embodiment,

FIG. 7 is a timing chart for a display device according to a fourth embodiment,

FIG. 8 is a timing chart for a display device according to a fifth embodiment,

FIG. 9 is a timing chart for a display device according to a sixth embodiment,

FIG. 10 is a diagram showing the basic structure of a conventional simple matrix display, and

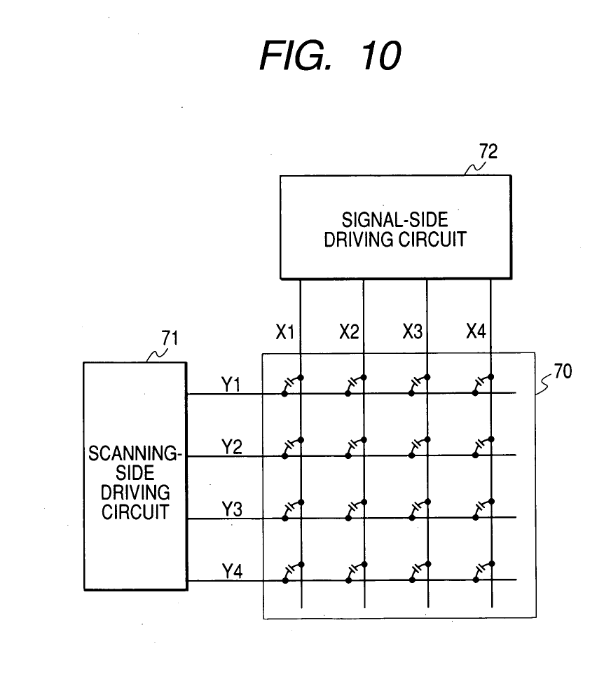

FIG. 11 is a timing chart for FIG. 10.

### DESCRIPTION OF THE PREFERRED EMBODIMENTS

An embodiment of a display driving method and a display device according to the invention will be described below with reference to the drawings.

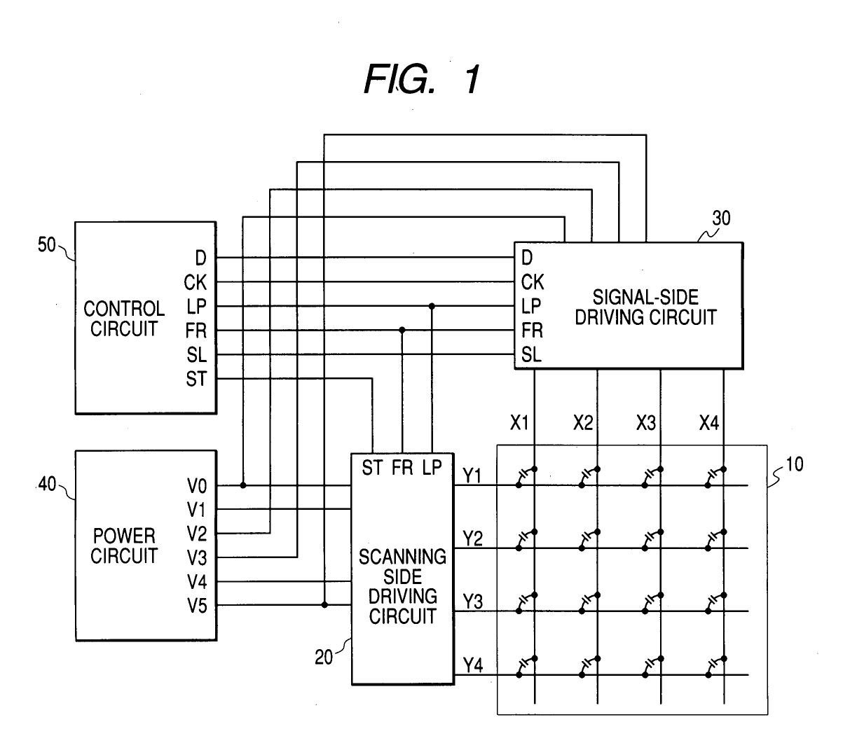

FIG. 1 is a diagram showing the schematic structure of a display device according to the embodiment of the invention, comprising a simple matrix display 10, a scanning side driving circuit 20, a signal side driving circuit 30, a power circuit 40 and a control circuit 50.

In FIG. 1, the display 10 is provided with a plurality of signal electrodes X (X1 to X4) and a plurality of scanning electrodes Y (Y1 to Y4) which are orthogonal to each other over two opposed substrates. Each of the signal electrodes X and the scanning electrodes Y is usually constituted by a large number of electrodes, that is, approximately several hundred electrodes. For easy understanding, there will be described an example in which four signal electrodes X and four scanning electrodes Y are provided. Liquid crystal display units or organic EL display units are interposed between the signal electrodes X and the scanning electrodes Y, and their intersections serve as display pixels. These intersections have a structure coupled by an electrostatic capacity and constitute a simple matrix display.

The power circuit 40 generates six kinds of voltages V0 to V5 which are required for carrying out alternating control over the display device, and supplies them to the scanning side driving circuit 20 and the signal side driving circuit 30, respectively. These voltages are set to have predetermined values so as to be sequentially increased (or reduced) from the voltage V0 toward the voltage V5. In the case in which the alternating control is not carried out, the number of the required voltages may be small.

The control circuit 50 forms display data, a clock and various control signals and supplies them to the scanning side driving circuit 20 and the signal side driving circuit 30, respectively. Display data D are PWM data for signal voltages to be applied to the signal electrodes X1 to X4 in order to control the display gradation of the display 10.

In the invention, it is possible to optionally select that the signal voltage is set to be a “rearward approach PWM signal voltage (hereinafter referred to as a rearward approach signal voltage)” to be applied to a rear portion in a predetermined width from a certain midway position to a final position for an interval period of a scanning clock LP or a “forward approach PWM signal voltage (hereinafter referred to as a forward approach signal voltage”) to be applied to a front portion in a predetermined width from a first part for the interval period of the scanning clock LP. For this reason, the display data D for each pixel include PWM data (hereinafter referred to as rearward approach data) D1 for the rearward approach signal voltage and PWM data (hereinafter referred to as forward approach data) D2 for the forward approach signal voltage. The display data D are supplied to the signal side driving circuit 30.

A data shift clock CK serves to shift the display data D and is supplied to the signal side driving circuit 30. The scanning clock LP serves as a scan signal supplied to the scanning side driving circuit 20 and scanning the scanning electrode Y, and furthermore, is supplied to the signal side driving circuit 30 to be a latch signal for latching the display data D for one line. An alternating signal FR is an inverting signal for alternating drive and is not required when the alternation is not carried out.

A select signal SL serves to select that the rearward approach data D1 or the forward approach data D2 of the supplied display data D are utilized, and is supplied to the signal side driving circuit 30.

A start signal ST serves to start scanning and is supplied to the scanning side driving circuit 20.

The scanning side driving circuit 20 generates predetermined scanning voltages on the scanning electrodes Y1 to Y4 upon receipt of the start signal ST, the scanning clock LP and the alternating signal FR, and at the same time, sequentially carries out scanning at a scanning clock interval.

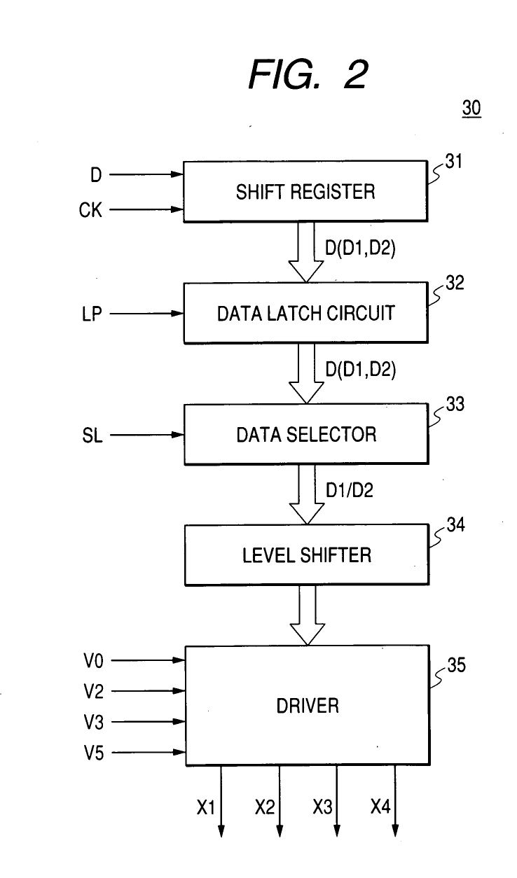

The internal structure of the signal side driving circuit 30 is shown in FIG. 2. A shift register 31 sequentially fetches and shifts the display data D (D1, D2) in response to the shift clock CK. A data latch circuit 32 latches the display data D (D1, D2) for one line in response to the scanning clock LP when the same display data D (DI, D2) are stored in the shift register 31.

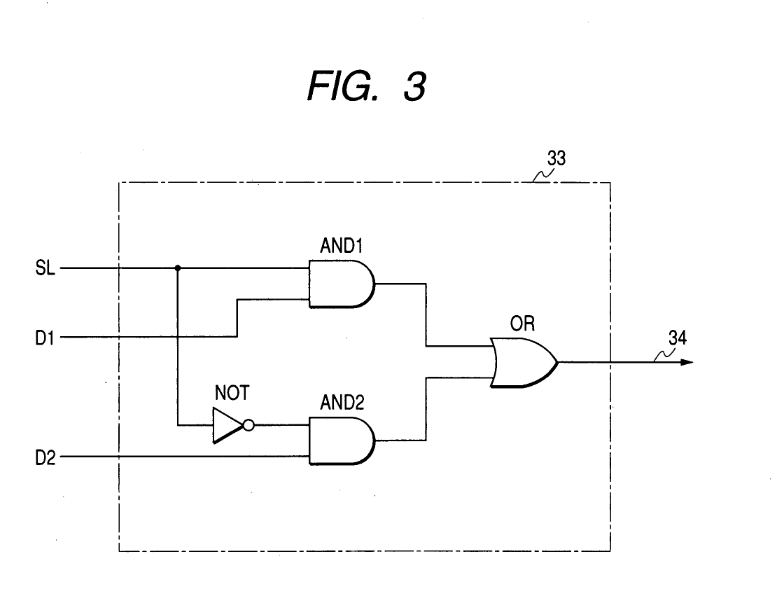

A data selector 33 is constituted by AND circuits AND1 and AND2, a NOT circuit NOT and an OR circuit OR as shown in FIG. 3, and the rearward approach data D1 or the forward approach data D2 in the display data D transmitted from the data latch circuit 32 are selected and output in response to the select signal SL. The selection is carried out in such a manner that the numbers of the forward approaches and the rearward approaches are almost equal to each other within an optional period for the scanning electrodes Y1 to Y4 every pixel data, every frame and every plural frames.

A level shifter 34 converts the level of the display data D1 or D2 selected from the data selector 33 and supplies the converted data to a driver 35. The driver 35 generates a rearward approach signal voltage or a forward approach signal voltage by voltages V0, V2, V3 and V5 applied from the power circuit 40 in accordance with the display data D1 or D2 thus level shifted, and supplies the signal voltage to the signal electrodes X1 to X4, respectively.

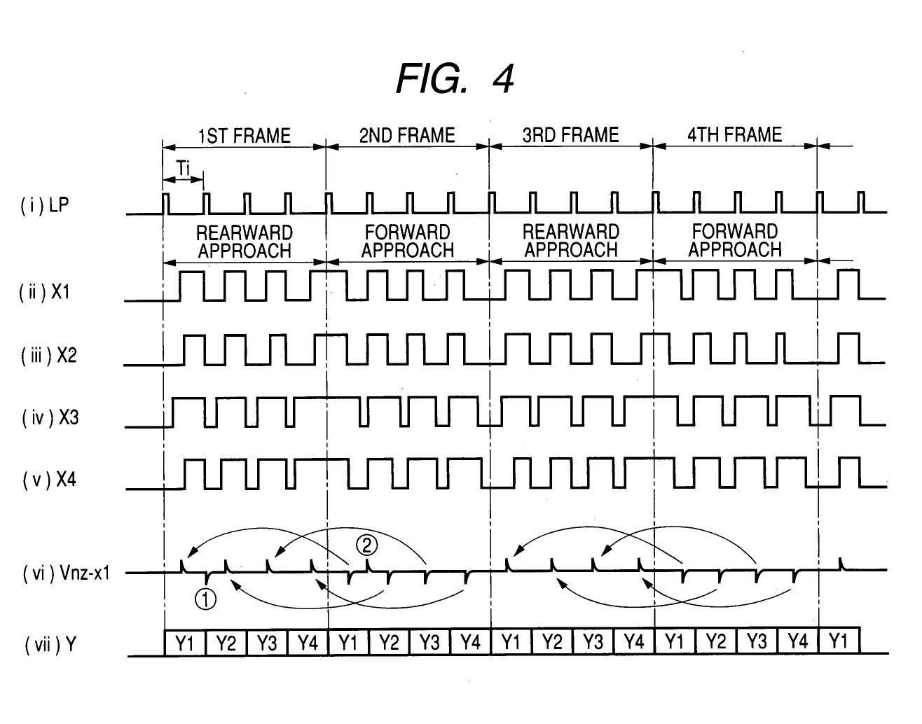

FIG. 4 is a timing chart for explaining the operation of a display device according to a first embodiment of the invention.

In FIG. 4, a scanning clock LP is output every scan interval Ti as shown in (i), and scanning electrodes Y1 to Y4 are sequentially selected repetitively for a scanning electrode Y every frame synchronously with the scanning clock LP as shown in (ii).

On the other hand, rearward approach signal voltages are supplied to signal electrodes X1 to X4 in a first frame. Accordingly, the rearward approach signal voltages rise in the midway of each scan interval Ti and the state is continuously maintained till an end thereof. Their rise timings are varied for each scan interval and the signal electrodes X1 to X4 in response to display data.

When the signal voltage rises, a positive noise voltage Vnz-x1 is generated in the first frame as typically shown in FIG. 4(vi) in relation to the signal electrode X1. The noise voltage Vnz-x1 fluctuates the electric potentials of the scanning electrodes Y1 to Y4 (the mainly selected scanning electrode, for example, Y1).

In a subsequent second frame, the forward approach signal voltages are supplied to the signal electrodes X1 to X4. Accordingly, the forward approach signal voltages fall in the midway of each scan interval Ti. Their fall timings are varied for the scan intervals and the signal electrodes X1 to X4 in response to the display data.

When the signal voltage rises, a negative noise voltage Vnz-x1 is generated in the second frame as typically shown in FIG. 4(vi) in relation to the signal electrode X1. The noise voltage Vnz-x1 fluctuates the electric potentials of the scanning electrodes Y1 to Y4 in a reverse direction to the first frame. Moreover, the influence of a cross talk is also increased with the noise voltage Vnz-x1.

Thus, the noise voltage Vnz-x1 is generated on a change point of the rise or fall of the signal voltage and the polarity of the noise voltage is reversed for each frame. Accordingly, the influences of the noise voltage Vnz-x1 are cancelled from each other as shown in an arrow of FIG. 4(vi) for a scanning period in which the scanning electrode Y1 is selected. Similarly, the noise voltages are cancelled for a scanning period in which the scanning electrodes Y2 to Y4 are selected, respectively. The same operation is carried out in and after a third frame. Furthermore, noises shown in \mathring{1} and \mathring{2}′ of the drawing are also generated for each end point of the interval period Ti of the scanning clock LP. These noises shown in \mathring{1} and \mathring{2}′ of the drawing have reverse polarities every frame.

Referring to the signal electrodes X2 to X4, moreover, the influences of noise voltages Vnz-x2 to Vnz-x4 are cancelled in the same manner described for the signal electrode X1.

Consequently, it is possible to substantially eliminate display shade and unevenness which have conventionally been caused by the noise voltage Vnz.

Moreover, the forward approach and the rearward approach may be switched every predetermined frame cycle (for example, every two cycles or every four cycles) in place of execution for each frame. Referring to a PWM signal voltage to be applied to each of the signal electrodes X1 to X4, the number of forward approaches is set to be almost equal to that of rearward approaches within an optional period for each scanning electrode (for example, Y1). Consequently, the influences, on screen display, of the noise voltage Vnz generated by the rise or fall of the signal voltage in PWM control are cancelled from each other. It is preferable that the optional period should be set within such a range that there is no problem in respect of the visibility of a displayed image.

In FIG. 4, furthermore, the forward approach signal voltages may be applied to the signal electrodes X3 and X4 in the first and third frames and the rearward approach signal voltages may be applied to the signal electrodes X3 and X4 in the second and fourth frames differently from the drawing, and they may be reverse to the signal voltages of the signal electrodes X1 and X2. Thus, it is also possible to cancel the influence of the noise voltage Vnz in the signal electrodes X1 and X2. The combination of the signal electrodes may be alternate (that is, X1, X3 and X2, X4) to divide all the signal electrodes X into two parts. This thought can also be applied to another embodiment of the invention.

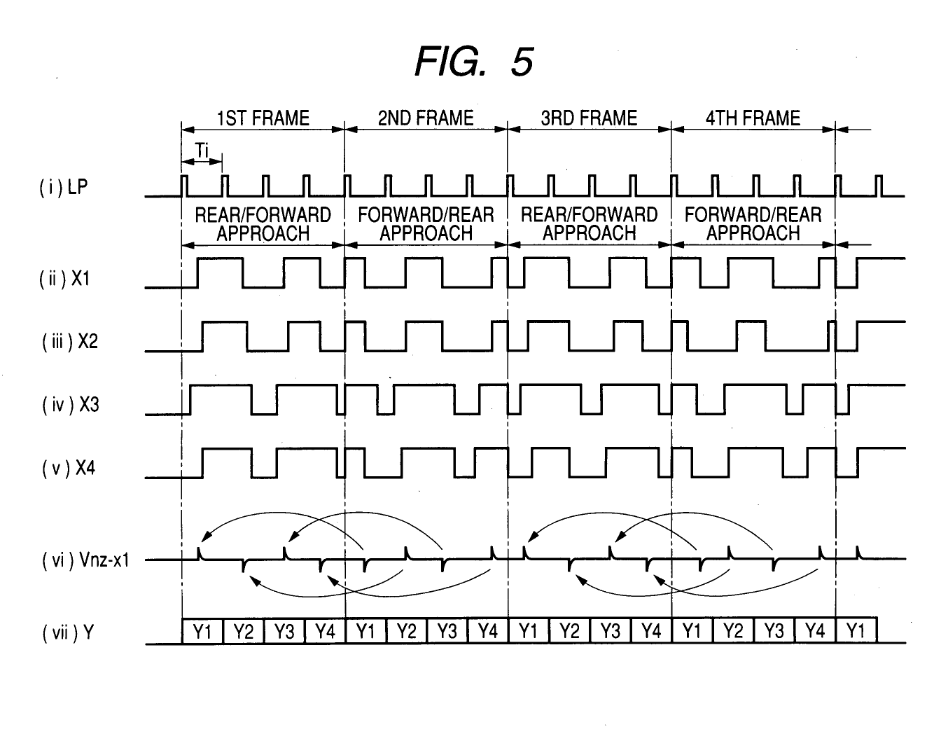

FIG. 5 is a timing chart for explaining the operation of a display device according to a second embodiment of the invention.

In FIG. 5, PWM signal voltages applied to signal electrodes X1 to X4 generate signal voltages having such a rearward/forward approach combination (hereinafter referred to as a rearward/forward approach signal voltage) that a rearward approach is carried out for a scanning period in which scanning electrodes Y1 and Y3, that is, odd-numbered scanning electrodes are selected and a forward approach is carried out for a scanning period in which scanning electrodes Y2 and Y4, that is, even-numbered scanning electrodes are selected in first and third frames. In second and fourth frames, moreover, there are generated signal voltages having such a forward/rearward approach combination (hereinafter referred to as a forward/rearward approach signal voltage) that the forward approach is carried out for the scanning period in which the scanning electrodes Y1 and Y3, that is, the odd-numbered scanning electrodes are selected and the rearward approach is carried out for the scanning period in which the scanning electrodes Y2 and Y4, that is, the even-numbered scanning electrodes are selected.

Referring to a noise voltage Vnz in this case, a noise voltage Vnz-x1 of positive—negative—positive—negative is generated in the first frame and a noise voltage Vnz-x1 of negative—positive—negative—positive is generated in the second frame as typically shown in FIG. 5(vi) in relation to the signal electrode X1.

Although the noise voltage Vnz-x1 is generated on the change point of the rise or fall of the signal voltage, thus, the polarity of the noise voltage Vnz-x1 is reversed corresponding to the scanning electrodes Y1 to Y4 for each frame. For a scanning period in which each of the scanning electrodes Y1 to Y4 is selected, accordingly, the influences of the noise voltage Vnz-x1 are cancelled from each other as shown in an arrow of FIG. 5(vi). The same operation is carried out in and after the third frame.

In the second embodiment, it is possible to cancel the influence of the noise voltage Vnz in the same manner as in the first embodiment. Furthermore, the rearward/forward approach signal voltage and the forward/rearward approach signal voltage are switched. Since the signal voltage of the signal electrode is not changed at each end point of an interval period Ti of a scanning clock LP, consequently, the change point of the PWM signal voltage is decreased. Accordingly, the noises shown in □ and □ of FIG. 4 (vi) are not generated and the change point of the PWM signal voltage is decreased. Therefore, it is possible to reduce an influence on a power voltage or a ground voltage.

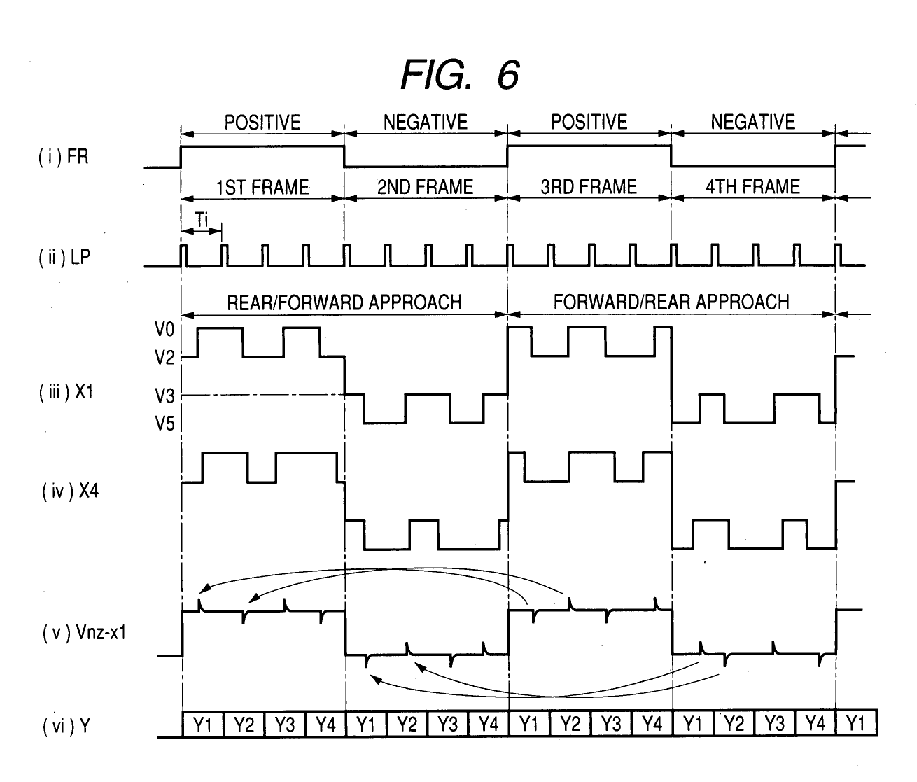

FIG. 6 is a timing chart for explaining the operation of a display device according to a third embodiment of the invention.

In FIG. 6, the control of an alternating signal is added to the second embodiment in FIG. 5.

In FIG. 6, as shown in (i), an alternating signal FR is switched to be positive or negative for each frame, thereby carrying out alternation. For this reason, as shown in (iii) and (iv), an ON voltage V0 and an OFF voltage V2 are applied as signal voltages to a signal electrode X, and a voltage V5 is applied to a scanning electrode Y at time of selection and a voltage V1 is applied to the scanning electrode Y at time of non-selection for a period in which the alternating signal FR is positive. On the other hand, for a period in which the alternating signal FR is negative, an ON voltage V5 and an OFF voltage V3 are applied as the signal voltages to the signal electrode X, and a voltage V0 is applied to the scanning electrode Y at time of the selection and a voltage V4 is applied to the scanning electrode Y at time of the non-selection. In FIG. 6, signal electrodes X2 and X3 are omitted.

In this example, the cycle of the alternating signal FR is synchronized with a rearward/forward approach signal voltage or a forward/rearward approach signal voltage. Accordingly, PWM signal voltages applied to the signal electrodes X1 to X4 generate rearward/forward approach signal voltages in which a rearward approach is carried out for a scanning period in which scanning electrodes Y1 and Y3, that is, odd-numbered scanning electrodes are selected and a forward approach is carried out for a scanning period in which scanning electrodes Y2 and Y4, that is, even-numbered scanning electrodes are selected in first and second frames. In third and fourth frames, moreover, there are generated forward/rearward approach signal voltages in which the forward approach is carried out for the scanning period in which the scanning electrodes Y1 and Y3, that is, the odd-numbered scanning electrodes are selected and the rearward approach is carried out for the scanning period in which the scanning electrodes Y2 and Y4, that is, the even-numbered scanning electrodes are selected in third and fourth frames.

Referring to a noise voltage Vnz in this case, a noise voltage Vnz-x1 of positive—negative—positive—negative is generated in the first and second frames and a noise voltage Vnz-x1 of negative—positive—negative—positive is generated in the third and fourth frames as typically shown in FIG. 6(v) in relation to the signal electrode X1. For example, the polarity of the voltage is inverted with the alternation in the first and second frames. Therefore, the noise voltage Vnz-x1 has an influence on screen display in the same direction.

Accordingly, the polarity of the noise voltage Vnz-x1 is reversed corresponding to the scanning electrodes Y1 to Y4 every two frames. FIG. 6(v) shows the influence of a noise on the scanning electrode Y and is an image diagram for easy understanding because a scanning voltage is varied depending on the selection or non-selection with the alternating control.

As shown in an arrow of FIG. 6(v), consequently, the influences of the noise voltage in the first frame and the noise voltage in the third frame are cancelled from each other and the influences of the noise voltage in the second frame and the noise voltage in the fourth frame are cancelled from each other for the scanning period in which each of the scanning electrodes Y1 to Y4 is selected.

The cycle of the alternating signal FR and the rearward/forward approach signal voltage or the forward/rearward approach signal voltage are not restricted to those in the example of FIG. 6 but proper cycles can be selected respectively.

In the third embodiment, it is possible to obtain the same advantages as those of the second embodiment. In the display of alternating drive, furthermore, it is possible to relieve the influence of the noise voltage irrespective of a change in the polarity of a driving voltage.

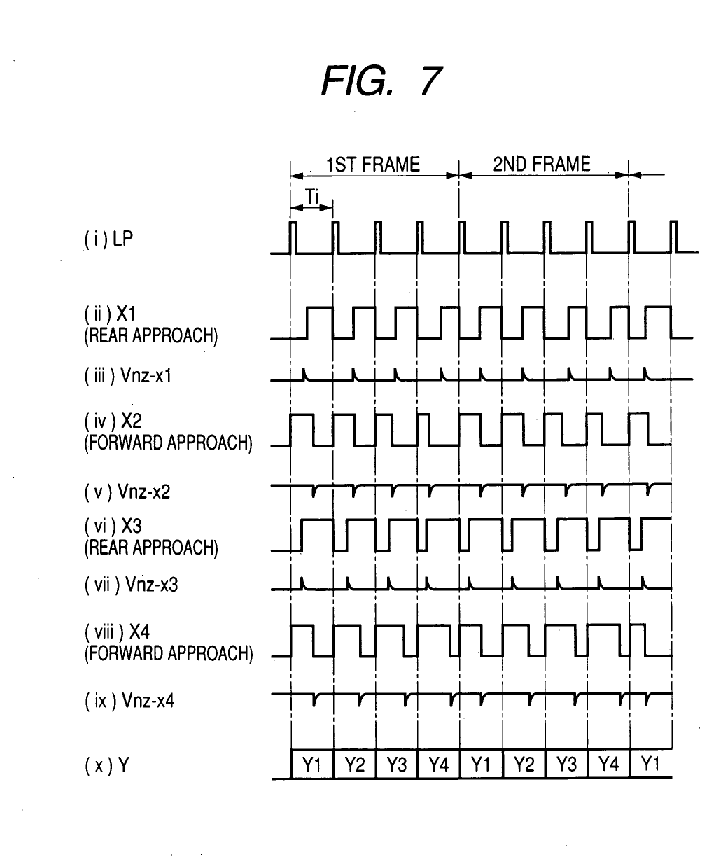

FIG. 7 is a timing chart for explaining the operation of a display device according to a fourth embodiment of the invention.

In FIG. 7, a scanning clock LP is output every scan interval Ti as shown in (i), and scanning electrodes Y1 to Y4 are sequentially selected repetitively for a scanning electrode Y every frame synchronously with the scanning clock LP as shown in (X).

On the other hand, a rearward approach signal voltage is supplied to the signal electrode X1. Accordingly, the rearward approach signal voltage rises in the midway of each scan interval Ti and the state is continuously maintained till an end thereof. A forward approach signal voltage is supplied to the signal electrode X2. Accordingly, the forward approach signal voltage is supplied from the beginning of each scan interval Ti and rises in the midway. Moreover, the rearward approach signal voltage is supplied to the signal electrode X3 and the forward approach signal voltage is supplied to the signal electrode X4. Each of the signal voltages has a width and rise and fall timings varied depending on the display data D every scan interval for each of the signal electrodes X1 to X4.

Positive noise voltages Vnz-x1 and Vnz-x3 are generated at time of the rise of the signal voltage in the signal electrodes X1 and X3 to which the rearward approach signal voltage is to be supplied as shown in FIG. 7(iii) and 7(vii), and the noise voltages Vnz-x1 and Vnz-x3 fluctuate the electric potentials of the scanning electrodes Y1 to Y4 (mainly the selected scanning electrode Y).

Negative noise voltages Vnz-x2 and Vnz-x4 are generated at time of the fall of the signal voltage in the signal electrodes X2 and X4 to which the forward approach signal voltage is to be supplied as shown in FIG. 7(v) and 7(ix), and the noise voltages Vnz-x2 and Vnz-x4 fluctuate the electric potentials of the scanning electrodes Y1 to Y4 (mainly the selected scanning electrode Y).

Referring to the scan electrode Y1, the positive noise voltages Vnz-x1 and Vnz-x3 are generated at time of the rise of the rearward approach signal voltage (the signal electrodes X1 and X3) as shown in FIGS. 7(iii) and 7(vii), while the negative noise voltages Vnz-x2 and Vnz-x4 are generated at time of the fall of the forward approach signal voltage (the signal electrodes X2 and X4) as shown in FIG. 7(v) and 7(ix)

Thus, the noise voltages Vnz-x1 to Vnz-x4 are generated on the change point of the rise or fall of the signal voltage and the polarity of the noise voltage is reversed for each signal electrode. Accordingly, the influences of the noise voltages Vnz-x1 to Vnz-x4 are cancelled from each other for a scanning period in which the scanning electrode Y1 is selected. Similarly, the influences of the noise voltages are cancelled from each other for a scanning period in which the scanning electrodes Y2 to Y4 are selected, respectively. Consequently, it is possible to substantially eliminate display shade and unevenness which have conventionally been caused by the noise voltage.

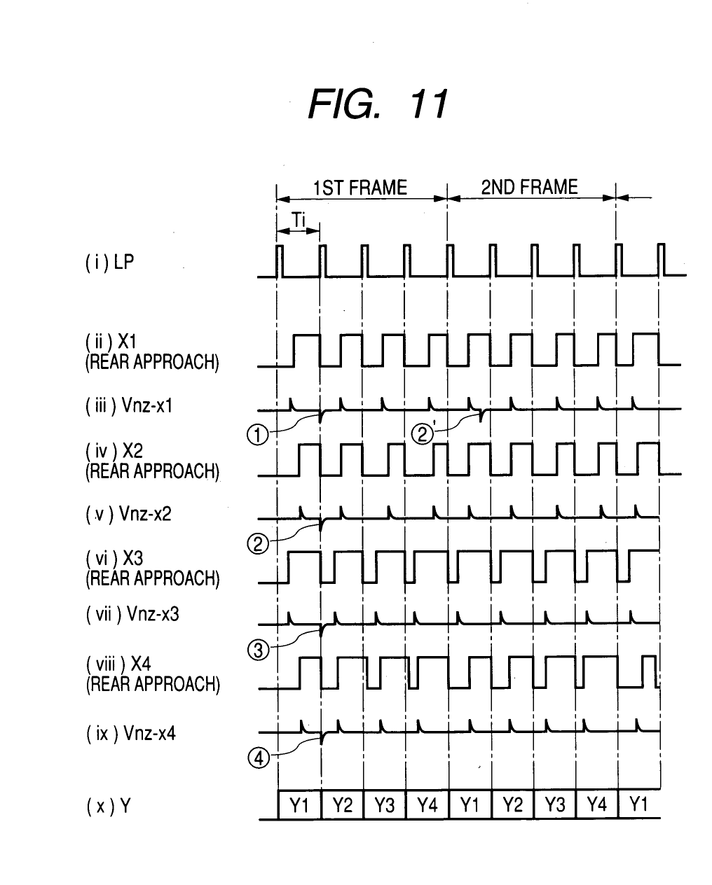

Moreover, the numbers of rises and falls of the signal voltage are almost equal to each other at time of the end of the interval period Ti of the scanning clock LP. Therefore, the noise voltages at time of the end of the interval period Ti shown in \mathring{1} to \mathring{4} of FIG. 11 according to the conventional art are cancelled from each other.

Furthermore, adjacent pixels often have similar tones. Accordingly, the pulse widths of the PWM signal voltages are almost equal to each other. For this reason, conventionally, a noise voltage has simultaneously been generated in the same direction to greatly influence picture quality. As in the embodiment of the invention, the forward and rearward approaches of the signal electrodes X1 to X4 are alternately carried out so that the noises of the adjacent pixels often having the same signal width are distributed to be positive and negative on a time base. Accordingly, it is possible to more expect the effect of suppressing a noise.

In FIG. 7, furthermore, a rearward approach signal voltage can be applied in a first frame and a forward approach signal voltage can be applied in a second frame for the signal electrodes X1 and X3, while the forward approach signal voltage can be applied in the first frame and the rearward approach signal voltage can be applied in the second frame for the signal electrodes X3 and X4. Thus, the influence of a noise voltage Vnz generated in each of the signal electrodes (for example, the signal electrode X1) can be cancelled between the frames (for example, the first and second frames). The influence of the noise voltage Vnz in each of the signal electrodes may be cancelled every optional number of frames (that is, every frame or every two frames). Moreover, the number of the rearward approach signal voltages may be almost equal to that of the forward approach signal voltages within a predetermined period. This thought can also be applied to another embodiment of the invention.

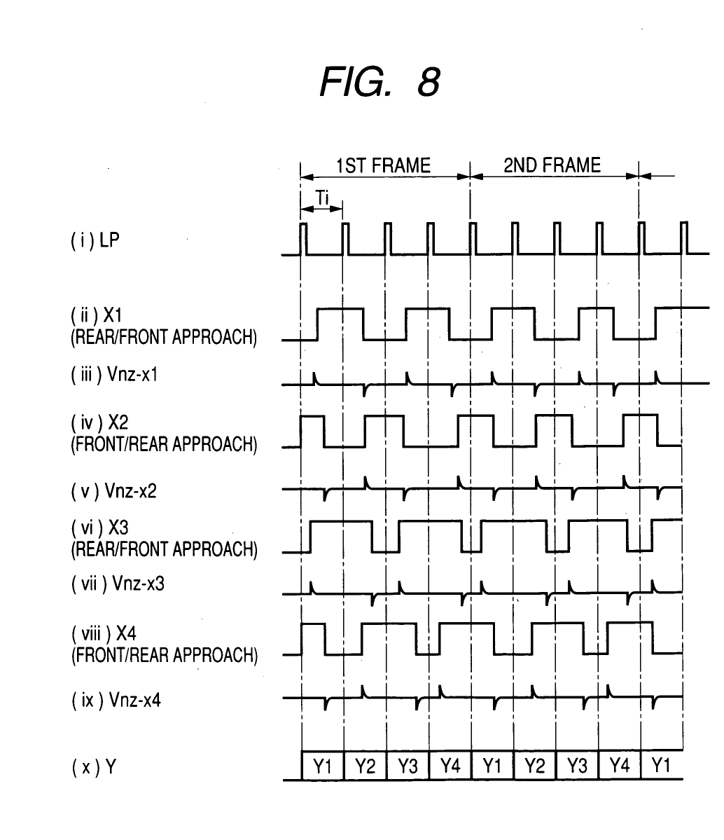

FIG. 8 is a timing chart for explaining the operation of a display device according to a fifth embodiment of the invention.

In FIG. 8, PWM signal voltages applied to signal electrodes X1 and X3 generate signal voltage shaving such a rearward/forward approach combination (hereinafter referred to as a rearward/forward approach signal voltage) that a rearward approach is carried out for a scanning period in which scanning electrodes Y1 and Y3, that is, odd-numbered scanning electrodes are selected and a forward approach is carried out for a scanning period in which scanning electrodes Y2 and YA, that is, even-numbered scanning electrodes are selected. Moreover, PWM signal voltages applied to signal electrodes X2 and X4 generate signal voltages having such a forward/rearward approach combination (hereinafter referred to as a forward/rearward approach signal voltage) that the forward approach is carried out for the scanning period in which the scanning electrodes Y1 and Y3, that is, the odd-numbered scanning electrodes are selected and the rearward approach is carried out for the scanning period in which the scanning electrodes Y2 and Y4, that is, the even-numbered scanning electrodes are selected.

Referring to a noise voltage Vnz in this case, noise voltages Vnz-x1 and Vnz-x3 of positive—negative—positive—negative are generated in accordance with scanning in each frame as shown in FIG. 8(iii) and 8(vii) in relation to the signal electrodes X1 and X3. Moreover, noise voltage Vnz-x2 and Vnz-x4 of negative—positive—negative—positive are generated in accordance with scanning in each frame as shown in FIG. 8(v) and 8(ix) in relation to the signal voltages X2 and X4.

Although the noise voltages Vnz-x1 to Vnz-x4 are generated on the change point of the rise or fall of the signal voltage, thus, the polarities of the noise voltages Vnz-x1 to Vnz-x4 are reversed corresponding to the scanning electrodes Y1 to Y4 for each signal electrode. For a scanning period in which each of the scanning electrodes Y1 to Y4 is selected, accordingly, the influences of the noise voltages Vnz-x1 to Vnz-x4 are cancelled from each other. The same operation is carried out in and after a second frame.

In the fifth embodiment, it is possible to cancel the influence of the noise voltage Vnz in the same manner as in the fourth embodiment. Since the rearward/forward approach signal voltage and the forward/rearward approach signal voltage are selected depending on the signal electrode, furthermore, the signal voltage of the signal electrode is not changed at each end point of an interval period Ti of a scanning clock LP. Accordingly, the change point of the PWM signal voltage is decreased. Therefore, it is possible to reduce the influence of a noise based on the change in the signal voltage on a power voltage or a ground voltage.

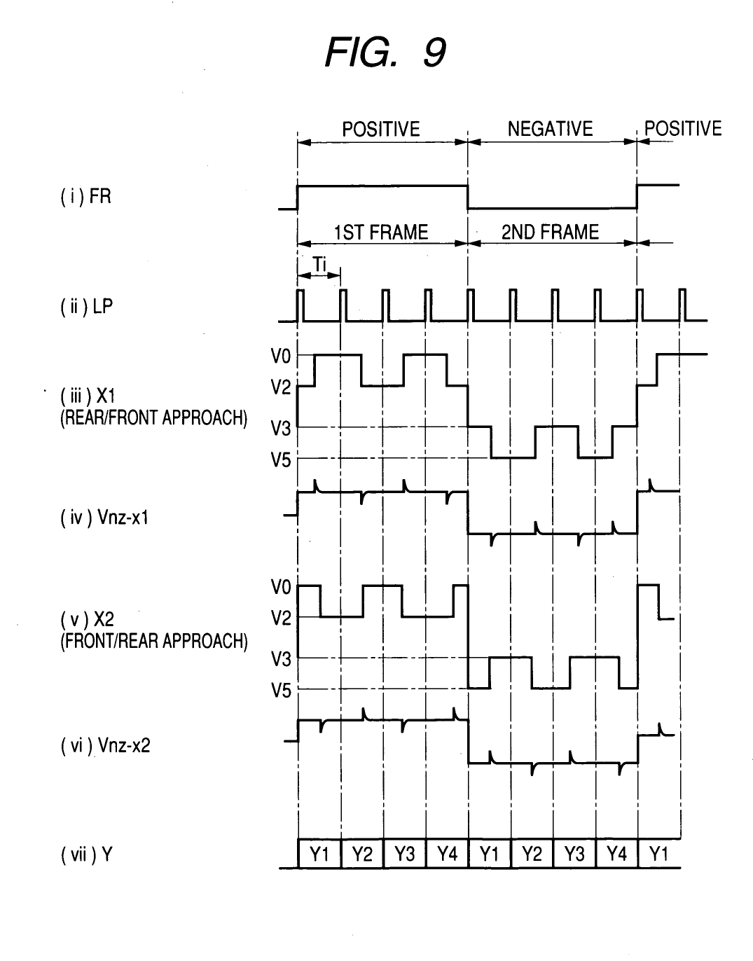

FIG. 9 is a timing chart for explaining the operation of a display device according to a sixth embodiment of the invention.

In FIG. 9, the control of an alternating signal is added to the fifth embodiment in FIG. 8.

In FIG. 9, as shown in (i), an alternating signal FR is switched to be positive or negative for each frame, thereby carrying out alternation. For this reason, an ON voltage V0 and an OFF voltage V2 are applied as signal voltages to a signal electrode X, and a voltage V5 is applied to a scanning electrode Y at time of selection and a voltage V1 is applied to the scanning electrode Y at time of non-selection for a period in which the alternating signal FR is positive. On the other hand, for a period in which the alternating signal FR is negative, an ON voltage V5 and an OFF voltage V3 are applied as the signal voltages to the signal electrode X, and a voltage V0 is applied to the scanning electrode Y at time of the selection and a voltage V4 is applied to the scanning electrode Y at time of the non-selection for a period in which the alternating signal FR is negative.

In this example, the cycle of the alternating signal FR is synchronized with a rearward/forward approach signal voltage or a forward/rearward approach signal voltage. Accordingly, PWM signal voltages applied to the signal electrodes X1 and X3 (the signal electrode X3 is not shown) generate such a rearward/forward approach signal voltage that a rearward approach is carried out for a scanning period in which scanning electrodes Y1 and Y3, that is, odd-numbered scanning electrodes are selected and a forward approach is carried out for a scanning period in which scanning electrodes Y2 and Y4, that is, even-numbered scanning electrodes are selected. Moreover, PWM signal voltages applied to the signal electrodes X2 and X4 (the signal electrode X4 is not shown) generate such a forward/rearward approach signal voltage that the forward approach is carried out for a scanning period in which the scanning electrodes Y1 and Y3, that is, the odd-numbered scanning electrodes are selected and the rearward approach is carried out for a scanning period in which the scanning electrodes Y2 and Y4, that is, the even-numbered scanning electrodes are selected.

Referring to a noise voltage Vnz in this case, a noise voltage Vnz-x1 of positive—negative—positive—negative is generated in each frame as shown in FIG. 9(iv) in relation to the signal electrode X1. As shown in FIG. 9(vi) in relation to the signal electrode X2, moreover, a noise voltage Vnz-x2 of negative—positive—negative—positive is generated in each frame. For example, in the first and second frames, the polarity of a voltage is inverted with alternation. Therefore, the noise voltages Vnz-x1 and Vnz-x2 have influences on screen display in the same direction.

Accordingly, the polarities of the noise voltages Vnz-x1 to Vnz-x4 are reversed corresponding to the scanning electrodes Y1 to Y4 every signal electrode. FIGS. 9(iv) and 9(vi) show the influence of a noise on the scanning electrode Y and are image diagrams for easy understanding because a scanning voltage is varied depending on the selection or non-selection with the alternating control.

As shown in a broken line of FIG. 9, consequently, the influences of the noise voltages Vnz-x1 to Vnz-x4 of the first electrodes X1 to X4 are cancelled from each other for a scanning period in which the scanning electrode Y1 is selected.

The cycle of the alternating signal FR and the rearward/forward approach signal voltage or the forward/rearward approach signal voltage are not restricted to those in the example of FIG. 5 but proper cycles can be selected, respectively.

In the sixth embodiment, it is possible to obtain the same advantages as those of the fifth embodiment. In the display of alternating drive, furthermore, it is possible to relieve the influence of the noise voltage irrespective of a change in the polarity of a driving voltage.

According to the invention, the PWM signal voltage to be applied to each of the signal electrodes X1 to X4 is controlled in such a manner that the forward approach and the rearward approach are almost equal to each other for each scanning electrode (for example, Y1) within an optional period. Therefore, the influences, on screen display, of a noise voltage generated at time of the rise (or fall) of the signal voltage in the PWM control are cancelled from each other. It is preferable that the optional period should be set within such a range that there is no problem in respect of the visibility of a displayed image. Consequently, it is possible to substantially eliminate display shade and unevenness which have conventionally been generated by the noise voltage.

Moreover, the switching of the forward approach and the rearward approach is carried out every predetermined frame cycle (for example, every cycle, every two cycles or every four cycles) so that matching with another display control can easily be taken.

Furthermore, the change point of the PWM signal voltage is decreased by the switching of the PWM signal voltage into the rearward/forward approach signal voltage and the forward/rearward approach signal voltage. Consequently, an influence on a power voltage or a ground voltage can be reduced. In the display of alternating drive, moreover, the influence of the noise voltage can similarly be relieved irrespective of a change in the polarity of a driving voltage.

Moreover, the forward approach and the rearward approach are set in such a manner that the signal electrode to which the forward approach signal voltage is to be applied and the signal electrode to which the rearward approach signal voltage is to be applied are alternated. Therefore, the noises of adjacent pixels often having the same signal width are distributed to be positive and negative on a time basis. Accordingly, it is possible to more expect the effect of suppressing a noise.

What is claimed is:

1. A display driving method of a simple matrix display for performing a PWM control,
wherein a forward approach PWM signal voltage and a rearward approach PWM signal voltage can be selectively supplied as PWM signal voltages so as to be applied to signal electrodes, and
the PWM signal voltage to be applied to each of the signal electrodes within a predetermined period is controlled in such a manner that numbers of the forward approach PWM signal voltages and the rearward approach PWM signal voltages are almost equal to each other in relation to each scanning electrode.

2. The display driving method according to claim 1, wherein the forward approach PWM signal voltage and the rearward approach PWM signal voltage are switched in every predetermined frame cycle.

3. The display driving method according to claim 1, wherein the PWM signal voltage is applied to have a rearward/forward approach combination in which the rearward approach PWM signal voltage is applied to an odd-numbered scanning electrode and the forward approach PWM signal voltage is applied to an even-numbered scanning electrode and a forward/rearward approach combination in which the forward approach PWM signal voltage is applied to the odd-numbered scanning electrode and the rearward approach PWM signal voltage is applied to the even-numbered scanning electrode.

4. The display driving method according to any of claims 1 to 3, wherein the PWM signal voltage and a scanning voltage to be applied to the scanning electrode are alternated synchronously to have a predetermined relationship with a frame cycle.

5. A display device comprising:
a simple matrix display provided with a plurality of signal electrodes and a plurality of scanning electrodes which are orthogonal to each other with an electrostatic capacity coupling display unit interposed therebetween;
a scanning side driving portion for sequentially scanning the scanning electrodes and supplying a scanning voltage; and
a signal side driving portion for supplying a PWM signal voltage to be a forward approach PWM signal voltage or a rearward approach PWM signal voltage to each of the signal electrodes synchronously with the scan of the scanning side driving portion,
wherein the signal side driving portion controls the PWM signal voltage in such a manner that numbers of the forward approach PWM signal voltages and the rearward approach PWM signal voltages are almost equal to each other within a predetermined period for each of the scanning electrodes.

6. The display device according to claim 5, wherein the signal side driving portion switches the forward approach PWM signal voltage and the rearward approach PWM signal voltage in every predetermined frame cycle.

7. The display device according to claim 5 or 6, wherein the signal side driving portion applies the PWM signal voltage to have a rearward/forward approach combination in which the rearward approach PWM signal voltage is applied to an odd-numbered scanning electrode and the forward approach PWM signal voltage is applied to an even-numbered scanning electrode or a forward/rearward approach combination in which the forward approach PWM signal voltage is applied to the odd-numbered scanning electrode and the rearward approach PWM signal voltage is applied to the even-numbered scanning electrode.

8. The display device according to claim 5 or 6, wherein the signal side driving portion and the scanning side driving portion synchronize and alternate the PWM signal voltage and a scanning voltage to be applied to the scanning electrode to have a predetermined relationship with a frame cycle.

9. A display driving method of a simple matrix display for performing a PWM control,
wherein numbers of signal electrodes to which a forward approach PWM signal voltage is to be applied and signal electrodes to which a rearward approach PWM signal voltage is to be applied are set to be almost equal to each other for each scanning period in which scanning electrodes are sequentially scanned.

10. The display driving method according to claim 9, wherein the signal electrode to which the forward approach PWM signal voltage is to be applied and the signal electrode to which the rearward approach PWM signal voltage is to be applied are set alternately.

11. The display driving method according to claim 9 or 10, wherein the PWM signal voltage is applied to have a rearward/forward approach combination in which the rearward approach PWM signal voltage is applied to an odd-numbered scanning electrode and the forward approach PWM signal voltage is applied to an even-numbered scanning electrode or a forward/rearward approach combination in which the forward approach PWM signal voltage is applied to the odd-numbered scanning electrode and the rearward approach PWM signal voltage is applied to the even-numbered scanning electrode.

12. The display driving method according to claim 9 or 10, wherein the PWM signal voltage and a scanning voltage to be applied to the scanning electrode are alternated synchronously to have a predetermined relationship with a frame cycle.

13. A display device comprising:
a simple matrix display provided with a plurality of signal electrodes and a plurality of scanning electrodes which are orthogonal to each other with an electrostatic capacity coupling display unit interposed therebetween;
a scanning side driving portion for sequentially scanning the scanning electrodes and supplying a scanning voltage; and
a signal side driving portion for supplying a PWM signal voltage to be a forward approach PWM signal voltage or a rearward approach PWM signal voltage to each of the signal electrodes synchronously with the scan of the scanning side driving portion,
wherein the signal side driving portion applies the forward approach PWM signal voltage to an almost half number of signal electrodes and applies the rearward approach PWM signal voltage to the residual signal electrodes for each scanning period in which the scanning electrodes are sequentially scanned.

14. The display device according to claim 13, wherein the signal side driving portion alternately sets the signal electrode to which the forward approach PWM signal voltage is to be applied and the signal electrode to which the rearward approach PWM signal voltage is to be applied.

15. The display device according to claim 13 or 14, wherein the signal side driving portion applies the PWM signal voltage to have a rearward/forward approach combination in which the rearward approach PWM signal voltage is applied to an odd-numbered scanning electrode and the forward approach PWM signal voltage is applied to an even-numbered scanning electrode or a forward/rearward approach combination in which the forward approach PWM signal voltage is applied to the odd-numbered scanning electrode and the rearward approach PWM signal voltage is applied to the even-numbered scanning electrode.

16. The display device according to a claim 13 or 14, wherein the signal side driving portion and the scanning side driving portion synchronize and alternate the PWM signal voltage and a scanning voltage to be applied to the scanning electrode to have a predetermined relationship with a frame cycle.
